(19) United States
(12) Patent Application Publication
(10) Pub. No.: US 2018/0170239 A1
(43) Pub. Date: Jun. 21, 2018

(54) LOAD SECURING SYSTEM AND METHOD FOR SECURING A LOAD

(71) Applicant: SCHOTT AG, Mainz (DE)

(72) Inventor: Andreas Dressel, Mitterteich (DE)

(73) Assignee: SCHOTT AG, Mainz (DE)

(21) Appl. No.: 15/846,267

(22) Filed: Dec. 19, 2017

(30) Foreign Application Priority Data
Dec. 19, 2016 (DE) 102016225442.1

(51) Int. Cl. B60P 7/16; B60P 3/00

(52) U.S. Cl. CPC B60P 7/16; B65D 81/02; B60P 3/00

(57) ABSTRACT

The present disclosure relates to a load securing system with at least two inflatable cushioning elements and fastening means for attachment of the cushioning elements to transported goods, wherein the at least two cushioning elements are in fluidic connection with one another by means of a connecting tube. The load securing system has a plurality of separate connectors. The method for securing a load provides that the inflatable cushioning elements are attached by means of fastening means to the transported goods, the transported goods are subsequently loaded, and the at least two cushioning elements are subsequently filled with a gas in a common step by means of one of a plurality of separate connectors, wherein a gas source is in fluidic connection with only one of the two cushioning elements or with the connecting tube.

### CROSS-REFERENCE TO RELATED APPLICATION

The present application claims the benefit of German Patent Application No. DE 10 2016 225 442.1, filed on Dec. 19, 2018, which is herein incorporated by reference.

### BACKGROUND OF THE DISCLOSURE

### 1. Field of the Disclosure

The present disclosure relates to a load securing system with at least two inflatable cushioning elements and fastening means for attachment of the cushioning elements to a transported good. The present disclosure further relates to a method for securing a load by means of such a load securing system and to the use of the load securing system for securing glass tubes that are combined into bundles.

### 2. Discussion of the Related Art

Generic load securing systems serve for securing larger transported goods inside of a cargo space, which is provided, for example, by a cargo container or by trucks, trailers, railroad cars, or other transport means. The transported goods are composed mostly of piece goods, which, combined individually or else in containers, are loaded on a pallet, for example. The containers are often fixed in place using a film or other retaining means.

Pallets or transported goods that are loaded in this way must be additionally secured against any shifting and/or tipping inside of the cargo space, because the cargo is frequently subjected to longitudinal and transverse forces during transport. For this reason, immediately during loading of the individual pallets or transported goods into the cargo space, supporting elements are already arranged in the intervening spaces between adjacent transported goods or pallets and also between the transported goods or pallets and the walls of the cargo space. For this purpose, as is known, sheets of cardboard or even air-filled cushions are employed.

A common approach is to place the cushioning elements, individually and without being fastened to the transported goods, in the intervening spaces and subsequently filling them with air until, expanded, they are wedged between the transported goods or pallets. In this case, the initial positioning of the cushioning elements is difficult, in particular when, for example, special transported goods permit support only at isolated places.

There are also cargo spaces in which, prior to loading, inflatable cushions are installed in fixed position along the wall of the cargo space, for example. In this connection, reference is made, for example, to the document DE 22 53 304 B. Described in it is a cargo space for the transport of pallets containing stacks of goods, for which inflatable sacks are arranged between the individual stacks of goods and are intended to prevent any shifting of the stacks of goods. The cargo space is divided by means of partition walls into successive chambers, in each of which a pallet fits. The partition walls are formed from surrounding partition frames, in the frame openings of which the inflatable sacks are arranged in fixed position. The partition walls, together with the cushions, form a predetermined fixed grid and are therefore not adapted individually to the shape and load-bearing capacity of the transported goods. As components of the cargo space, the sacks accordingly do not form a generic load securing system that is characterized in that it can be attached directly to the transported goods and, as a result of which, a greater flexibility and a better protection are made possible.

Another solution is known, for example, from the document DE 299 12 047 U1. The transport device discussed therein is composed of a pallet and a double-walled retaining means, which engages at the container stacked on the pallet and fixes it in place. For this purpose, the retaining means has fastening means for fastening at or on the goods and/or the pallet. Furthermore, the double-walled retaining means has a cavity that can be filled with compressed air and, owing to the expansion thereof, presses the transported goods against one another or onto the pallet. Accordingly, therefore, the purpose of the retaining means is to fix the transported goods in place on a pallet.

DE 89 04 373 U1 discloses a reusable packing, which is composed of two annular tubes, which are connected through a total of four additional tubes or struts and are spaced apart. The tubes preferably have a common cavity. Therefore, only one valve is also provided for filling and emptying the cavity. The individual tubes can each have its own cavity, wherein, in this case, each cavity or each tube is equipped with a valve. In addition, it is proposed to fix in place the individual elements of the packing at the article to be packed by using securing elements, in particular bands or straps.

A packing system with a plurality of air cushions is shown in EP 0 394 497 A1. The air cushions are connected to one another through a common air channel, wherein the air channel is to have a valve inside of each air cushion. By means of the common air channel, air can be introduced into the air cushion, as a result of which the air cushion is inflated. The valves are self-closing, so that no air can escape.

DE 694 14 242 T2 also discloses inflatable packing elements, which are to be employed as corner protectors. In this case, this publication discloses a system with four corner protectors, which are connected to one another via a common channel system. The channel system has a single valve for filling all four corner protectors with air.

US 2016/0340102 A1 also discloses inflatable packing elements, which are provided, in particular, for corners. However, the individual packing elements are not in fluidic connection with one another. It is proposed that the packing elements are fastened by means of bands to the articles to be packed.

U.S. Pat. No. 5,833,413 discloses a loading system for a truck, for which inflatable elements can be fixed in place by means of a network of belts in a loading space of a truck and, in this way, serve as barriers for loaded goods. In this case, too, the inflatable elements each have exactly one valve and are in fluidic connection with one another at most during inflation, but not during transport.

DE 20 2015 102 867 U1 shows a transport container that is composed of two tub-shaped, half-shell-like hollow bodies. The hollow bodies are inflatable, dimensionally stable in the filled state, and joined to one another in the manner of a suitcase. In the interior space of the two tub-shaped hollow bodies, it is possible to arrange a transported article, which, in this way, is protected against being shaken. It is also proposed that the two cavities of the hollow bodies that can be filled with air are connected to each other and filled by means of a common filling valve. Alternatively, it is proposed to provide each of the annular chambers of the hollow bodies with a separate filling valve. Another alterative consists in dividing the annular chambers into a plurality of separate chambers.

### SUMMARY OF THE DISCLOSURE

The object of the present disclosure is to provide a load securing system and a method for securing a load that permit a simple handling even in the case of special transported goods.

The object is achieved by a load securing system in accordance with claim 1 and a method for securing a load in accordance with claim 7. The load securing system according to the disclosure of the kind mentioned in the introduction provides that the at least two cushioning elements are in fluidic connection with one another by means of a connecting tube. In addition, the load securing system according to the present disclosure has a plurality of separate connectors.

The fluidic connection permits a simple filling of the at least two cushioning elements in one step, because it is not necessary to fill each of the cushioning elements individually. This shortens the loading time and it is not even necessary to access each individual cushioning element in the generally cramped cargo spaces for the purpose of filling. In addition, the fluidic connection brings about a compensation in pressure between the connected cushioning elements, even during transport. This is advantageous in comparison with fluidically separated individual elements when a locally arising pressure initially acts on only one of the cushioning elements. Due to the pressure compensation in the system according to the present disclosure, the pressure is gradually distributed onto both cushions and hence over a larger surface area, thereby reducing the risk of transport damage. At the same time, the pressure compensation takes place more slowly through the connecting tube, because the latter throttles the flow. This damping contributes to the fact that the connected cushioning elements nonetheless adequately support the transported goods. At the same time, the cushioning elements are separated physically from each other, apart from the tube connection, so that they can be attached to the transported goods individually and with the greatest possible degree of flexibility.

The method according to the present disclosure for securing a load by means of a load securing system, which has a plurality of separate connectors, accordingly provides that the at least two inflatable cushioning elements, which are in fluidic connection with one another by means of a connecting tube, are attached by means of fastening means to transported goods that are to be loaded, which are subsequently loaded, and the at least two cushioning elements subsequently are filled with a gas in one step by means of one of the connectors, wherein a gas source is in fluidic connection with only one of the two cushioning elements or with the connecting tube.

Coming into consideration as a gas is preferably air. The gas source can preferably be a blower or a pump.

Through the prior attachment of the fastening means directly to the transported goods that are to be loaded, it is possible to ensure that the cushioning is employed precisely at the required places, without it being necessary to hold the cushioning on site in the cramped cargo space. The fluidic connection at once ensures that, after loading, it is possible for poorly accessible or even no longer accessible cushioning elements to be filled with the gas in a simple way.

Preferably, the fastening means are flexible. This ensures that, during filling, the cushioning element is not fixed in place by the fastening means in such a way that constrictions or the like arise, which can prevent an expansion of the cushioning elements.

Preferably, the fastening means comprise a band and, more preferably an elastic band, with which the cushioning elements can be attached to the transported goods or are attached thereto.

In accordance with the method, this preferably happens in that the elastic band is initially attached to the transported goods by initially stretching it over the transported good and subsequently clamping the at least two cushioning elements between the band and the transported goods.

Preferably, one of the at least two inflatable cushioning elements and/or the connecting tube have or has a connector for filling.

The connector serves for connection with the gas source. More preferably, it has a valve. In any case, the connectors or valves are suitable for filling and optionally also for emptying. In the latter case, the cushioning elements can be reused.

In principle, one connector suffices for each load securing system, because all of the cushioning elements according to the present disclosure that are included in them are in fluidic connection with one another by means of the connecting tube. However, the load securing system according to the present disclosure has a plurality of connectors and, more preferably, each of the cushioning elements has a separate connector, in order that, when the cushioning element is attached to the transported goods and when the latter is loaded, it is not necessary to pay attention to the position of the connectors and, in spite of this, one connector is readily accessible at all times. For a more uniform filling of the at least two cushioning elements, it is advantageous when a connector is arranged in the region of the connecting tube and, more preferably, is arranged in the middle of the connecting tube.

A use of the load securing system in accordance with the present disclosure serves for securing glass tubes that are combined into bundles, with said bundles being stacked on a pallet. At least two inflatable cushioning elements, which, in turn, are in fluidic connection by means of a connecting tube, are attached, as described above, by means of fastening means on the same side of the stack, spaced apart from one another, respectively near to the front end and near to the back end of the glass tube bundles. The pallet is subsequently loaded and the at least two cushioning elements are filled with a gas in a common step, wherein a gas source is in fluidic connection with only one of the two cushioning elements or with the connecting tube.

Further features and advantages of the present disclosure will be described below on the basis of an exemplary embodiment.

### DESCRIPTION OF THE FIGURE

FIG. 1 shows the load securing system according to the present disclosure on transported goods on a pallet in perspective illustration.

### DETAILED DESCRIPTION OF THE DISCLOSURE

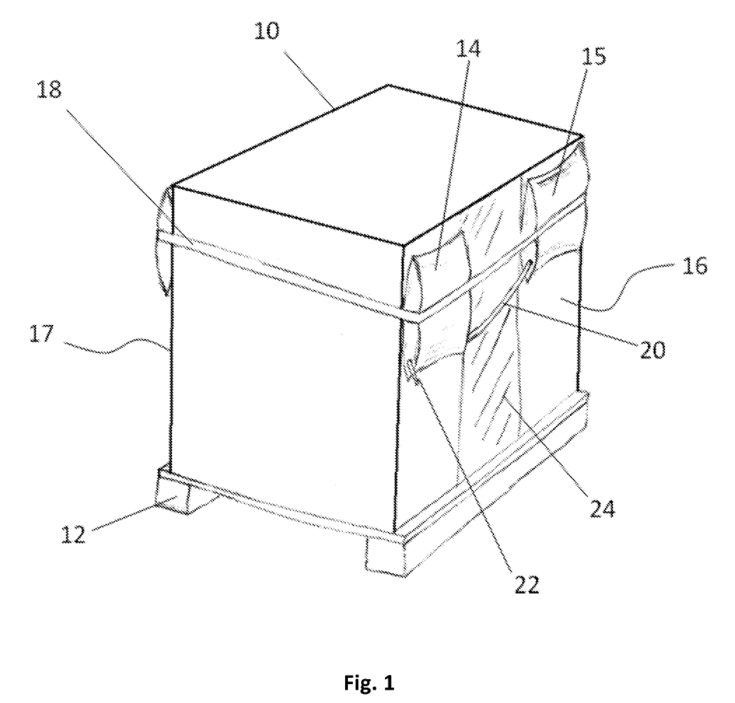

Illustrated in FIG. 1 are transported goods 10 as, by way of example, a rectangular box, which is arranged on a pallet 12. The box, for example, can be composed of a container of a plurality of individually layered transported goods. For the purpose of fixing the transported good in place, it is possible, in a known way, to wrap it with plastic film. It is understood that, in place of the rectangular box, also transported goods of any other shape can be packed.

In its top region, the transported goods 10 have a load securing system with two inflatable cushioning elements 14 and 15 on the longitudinal side 16 of the pallet 12 facing the observer. The same arrangement is also found on the longitudinal side 17 of the pallet 12 facing away from the observer. The cushioning elements 14, 15 are attached to the transported goods 10 by means of a fastening means in the form of an elastic band 18. The band 18 runs around the periphery of the transported goods 10 and, in this way, also surrounds the cushioning elements arranged on the opposite side.

The elastic band 18 can be endless in design and then is passed over the transported goods for fastening from the top side. Subsequently, the cushioning elements 14, 15 are clamped in place between the band and the side of the transported goods.

Alternatively, the band can also be open in design and can be wound around the transported goods 10 and then, for example, knotted or, after being wound around, fastened adhesively to the surface of the transported goods and/or at adjacent positions of the band. Optionally, a clamping strap can also be used, which, after being wound around the transported goods 10, is tightened and fixed in place using a clamping device. The fixing in place can take place, in turn, in such a way that the band can be released in a non-destructive manner or in a manner that is not non-destructive. In these cases, the band may also be less flexible or not very flexible at all. Coming into consideration as fastening means are, for example, also Velcro straps, fabric straps, rubber straps, or straps made of plastic film.

The two cushioning elements 14, 15 are in fluidic connection with each other by means of a connecting tube 20. Furthermore, the cushioning element 14 has a connector 22, by way of which, initially, the cushioning element 14 and, finally, via the connecting tube 20, the cushioning element 15 can also be filled with a gas, preferably air. This is similarly applicable to the two cushioning elements arranged on the side facing away. Optionally, however, those cushioning elements can also be connected by way of another connecting tube to one of the two cushioning elements 14 or 15, so that all cushioning elements can be filled in one operating step. Of course, depending on the requirement, other cushioning elements can be arranged at the two front ends, on the top side, or further in the bottom region of the transported goods 10 next to the pallet 12. Moreover, the cushioning elements can also be of different size and shape.

In FIG. 1, it is assumed that the transported goods 10 cannot be supported in the hatched region 24 along the longitudinal sides 16, 17 by means of cushioning elements. This could lie in the fact, for example, that a cavity is situated at that place, so that a support cannot thereby occur. Another case of application could be that the transported goods should not be supported in the region 24, because an increased risk of breakage or an increased sensitivity to pressure exists there. In such cases of application, a large air cushion that acts on the entire longitudinal side of the transported goods 10 does not come into consideration. For this reason, the at least two spatially separated cushioning elements 14, 15 are provided. In order for the latter to able to be handled during loading and filling just as simply as an individual cushioning element, the present disclosure provides the very connecting tube 20. The attachment by means of fastening means prior to loading simplifies the operation still further.

A case of application is the use of the load securing system according to the present disclosure for securing glass tubes that are combined into bundles. More preferably, the individual glass tubes are packed in tightest packing to form commercial bundles and are held together at both tube ends in each case by means of a film, preferably a shrink film made of polyethylene (PE). This imparts a high dimensional stability to the bundle without additional supporting spacing elements and protects the individual tubes against any further shifting with respect to one another. The risk of scratching and of point contacts and hence the risk of breakage is thereby reduced. In addition, the film material does not abrade, as is the case for paper or cardboard, for example and, at the same time, seals the ends of the tubes. In this way, soiling can be doubly prevented. Moreover, the film is transparent, so that visual inspection can take place without removal of the packing. And finally, the film material is very thin and therefore minimizes the packing volume.

Such bundles can be stacked and can therefore be stacked on a pallet 12. It has proven advantageous, in addition, to pull a shrink cover over the pallet containing the stacked bundles. The shrink cover can also be made of PE. The shrink cover imparts additional stability and strength to the entire stack and tightly seals the stack against environmental influences.

Whereas, the bundles of tubes at the tube ends, where they are held together by means of the film, mutually supporting one another, exhibit a high compressive strength, this strength is reduced in the middle of the tube, because, there, less mutual support exists. For this reason, at such a stack, at least two of the inflatable cushioning elements 14, 15, which are in fluidic connection with one another by means of a connecting tube 20, are to be attached at the same side of the stack, spaced apart from each other, by means of fastening means, respectively near to the front end and near to the back end of the glass tubes or bundles of glass tubes. Thus, the pallet can subsequently be loaded and the at least two cushioning elements 14, 15 can be filled one time with a gas (air) in the loaded state, wherein the gas source needs to be connected to only one of the two cushioning elements 14, 15 or to the connecting tube 20, depending on which is more readily accessible.

### LIST OF REFERENCE SIGNS

10 transported goods
12 pallet
14 inflatable cushioning element
15 inflatable cushioning element
16 longitudinal side
17 longitudinal side
18 band
20 connecting tube
22 connector

What is claimed is:

1. A load securing system with at least two inflatable cushioning elements and fastening means for attachment of the cushioning elements on transported goods,
wherein the at least two cushioning elements are in fluidic connection with one another by with a connecting tube,
wherein the load securing system has a plurality of separate connectors.

2. The load securing system according to claim 1, wherein the fastening means are flexible.

3. The load securing system according to claim 1, wherein the fastening means comprise a band, with which the cushioning elements can be attached to the transported goods.

4. The load securing system according to claim 1, wherein one of the at least two inflatable cushioning elements and/or the connecting tube have a connector for filling.

5. The load securing system according to claim 4, further characterized in that the connector comprises a valve.

6. The load securing system according to claim 1, wherein each of the cushioning elements has a separate connector.

7. A method for securing a load with a load securing system having a plurality of separate connectors, wherein the load securing system comprises at least two inflatable cushioning elements, wherein the at least two inflatable cushioning elements are which are in fluidic connection with one another via a connecting tube, and are attached with fastening means to transported goods that are to be loaded, comprising the steps of:
loading the transported goods; and
filling the at least two cushioning elements with a gas in a common step with one of the connectors,
wherein a gas source is in fluidic connection with only one of the two cushioning elements or with the connecting tube.

8. The method according to claim 7, wherein the at least two cushioning elements are attached, spaced apart from one another, on the same side of the transported goods.

9. The method according to claim 7, wherein the at least two cushioning elements are attached by means of a band to the transported goods.

10. The method according to claim 9, wherein the at least two cushioning elements are attached by means of an elastic band to the transported goods by initially stretching the band over the transported goods and subsequently clamping the at least two cushioning is elements between the band and the transported goods.

11. A method of securing glass tubes that are combined into bundles, using the load securing system of claim 1, wherein the bundles are stacked on a pallet, the method comprising the steps of:
attaching the at least two inflatable cushioning elements, so that they are in fluidic connection with one another via the connecting tube;
spacing the at least two inflatable cushioning elements apart from one another, with fastening means on the same side of the stack, near to a front end and near to a back end of the bundles of glass tubes;
loading the pallet; and
filling the at least two cushioning elements with a gas in a common step via one of the connectors,
wherein a gas source is in fluidic connection with only one of the two cushioning elements or with the connecting tube.
